(19) United States
(12) Patent Application Publication
(10) Pub. No.: US 2026/0140415 A1
(43) Pub. Date: May 21, 2026

(54) LIGHT ADJUSTMENT DEVICE

(71) Applicant: Japan Display Inc., Tokyo (JP)

(72) Inventors: Kojiro IKEDA, Tokyo (JP); Takeo KOITO, Tokyo (JP); Tae KUROKAWA, Tokyo (JP); Yoshinori TANAKA, Tokyo (JP)

(21) Appl. No.: 19/446,078

(22) Filed: Jan. 12, 2026

Related U.S. Application Data
(63) Continuation of application No. PCT/JP2024/018586, filed on May 21, 2024.

(30) Foreign Application Priority Data
Jul. 18, 2023 (JP) 2023-116610

(51) Int. Cl. G02F 1/1347; G02F 1/1333; G02F 1/1339; G02F 1/1343

(52) U.S. Cl. CPC G02F 1/1347; G02F 1/133345; G02F 1/1339; G02F 1/134309

(57) ABSTRACT

According to an aspect, a light adjustment device includes a panel unit in which a plurality of light adjustment panels are stacked in a first direction, At least one of the light adjustment panels includes a first substrate, a second substrate overlapping the first substrate when viewed along the first direction, a liquid crystal layer with which a space between the first substrate and the second substrate is filled, a first electrode stacked on the first substrate, a second electrode stacked on the second substrate, and an insulating layer containing at least one of silicon nitride or silicon oxide. The insulating layer is stacked on at least one of the first substrate or the second substrate and is provided in an active area.

### CROSS-REFERENCE TO RELATED APPLICATION

This application claims the benefit of priority from Japanese Patent Application No. 2023-116610 filed on July 18, 2023 and International Patent Application No. PCT/JP2024/018586 filed on May 21, 2024, the entire contents of which are incorporated herein by reference.

### BACKGROUND

### 1. Technical Field

What is disclosed herein relates to a light adjustment device.

### 2. Description of the Related Art

A light adjustment device including a plurality of stacked light adjustment panels is disclosed in Japanese Patent Application Laid-open Publication No. 2010-230887. When incident light enters the light adjustment panel, the light transmittance of the incident light is adjusted in the light adjustment panel and the transmitted light thus adjusted is output from the light adjustment device. In the light adjustment device, light adjustment panels vertically adjacent to each other are joined together with an optical bonding agent such as OCA.

In order to reduce decrease in light transmittance, no insulating layer formed of, for example, SiN, is provided in an active area in which a liquid crystal layer is provided. However, in this case, the color temperature of light emitted from a light adjustment device potentially decreases.

### SUMMARY

According to an aspect, a light adjustment device includes a panel unit in which a plurality of light adjustment panels are stacked in a first direction, At least one of the light adjustment panels includes a first substrate, a second substrate overlapping the first substrate when viewed along the first direction, a liquid crystal layer with which a space between the first substrate and the second substrate is filled, a first electrode stacked on the first substrate, a second electrode stacked on the second substrate, and an insulating layer containing at least one of silicon nitride or silicon oxide. The insulating layer is stacked on at least one of the first substrate or the second substrate and is provided in an active area.

### BRIEF DESCRIPTION OF THE DRAWINGS

FIG. 1 is a schematic diagram of each light adjustment panel according to a first embodiment when viewed from the upper side;

FIG. 2 is a schematic diagram illustrating a section of FIG. 1;

FIG. 3 is a plan view of a first substrate according to a first embodiment;

FIG. 4 is a plan view of a second substrate according to the first embodiment;

FIG. 5 is a plan view of each light adjustment panel obtained by placing the second substrate in FIG. 4 on the upper side of the first substrate in FIG. 3;

FIG. 6 is a schematic diagram of four light adjustment panels constituting a light adjustment device according to the first embodiment;

FIG. 7 is a schematic diagram illustrating a section of the light adjustment device according to the first embodiment;

FIG. 8 is a sectional view of a light adjustment panel according to a modification of the first embodiment;

FIG. 9 is a graph illustrating chromaticity in a case where an insulating layer is disposed in an active area and in a case where no insulating layer is not disposed in the active area;

FIG. 10 is a sectional view of a light adjustment panel according to a second embodiment;

FIG. 11 is a plan view of a first substrate according to the second embodiment;

FIG. 12 is a plan view of a second substrate according to the second embodiment;

FIG. 13 is a plan view of a light adjustment panel obtained by placing the second substrate in FIG. 12 on the upper side of the first substrate in FIG. 11;

FIG. 14 is a sectional view of a light adjustment panel according to a modification of the second embodiment;

FIG. 15 is a sectional view of a light adjustment panel according to another modification of the second embodiment;

FIG. 16 is a plan view of a first substrate according to a third embodiment;

FIG. 17 is a plan view of a second substrate according to the third embodiment;

FIG. 18 is a plan view of a light adjustment panel obtained by placing the second substrate in FIG. 17 on the upper side of the first substrate in FIG. 16;

FIG. 19 is a plan view of a first substrate according to a fourth embodiment;

FIG. 20 is a plan view of a second substrate according to the fourth embodiment;

FIG. 21 is a plan view of a light adjustment panel obtained by placing the second substrate in FIG. 20 on the upper side of the first substrate in FIG. 19; and

FIG. 22 is a schematic diagram illustrating a section of a panel unit according to a modification.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the right-left direction, and an X1 side is opposite an X2 side. The X1 side is also referred to as a left side, and the X2 side is also referred to as a right side. A Y direction is the front-back direction, and a Y1 side is opposite a Y2 side. The Y1 side is also referred to as a front side, and the Y2 side is also referred to as a back side. A Z direction is the up-down direction (stacking direction). A Z1 side is opposite a Z2 side. The Z2 side is also referred to as an upper side, and the Z1 side is also referred to as a lower side. The Z direction is also referred to as a first direction.

### First Embodiment

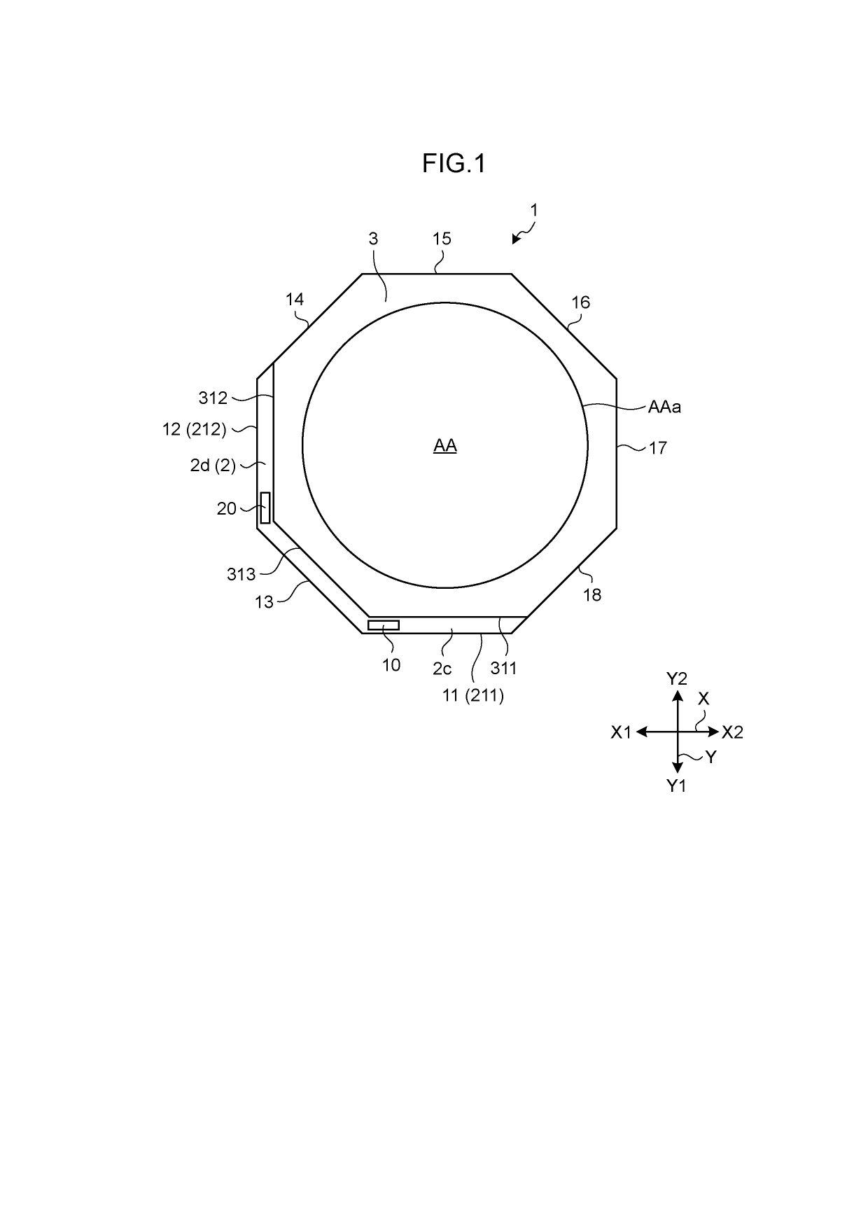

First, a light adjustment panel 1 is described below. FIG. 1 is a schematic diagram of each light adjustment panel according to the first embodiment when viewed from the upper side.

As illustrated in FIG. 1, each light adjustment panel 1 includes a first substrate 2 and a second substrate 3 disposed on the upper side (Z2 side) relative to the first substrate 2. Each light adjustment panel 1 is an octagon in plan view and has a first side 11, a second side 12, a third side 13, a fourth side 14, a fifth side 15, a sixth side 16, a seventh side 17, and an eighth side 18. In the present invention, the shape of each light adjustment panel 1 is not particularly limited, and polygons other than octagons as well as circles and ellipses are included in the present invention.

An end part 2c of the first substrate 2 on the Y1 side is exposed at the first side 11. A first terminal group 10 is provided at the end part 2c. The first terminal group 10 is provided on the X1 side at the end part 2c.

An end part 2d of the first substrate 2 on the X1 side is exposed at the second side 12. A second terminal group 20 is provided at the end part 2d. The second terminal group 20 is provided on the Y1 side at the end part 2d. An active area AA is positioned inside a circular edge AAa in plan view.

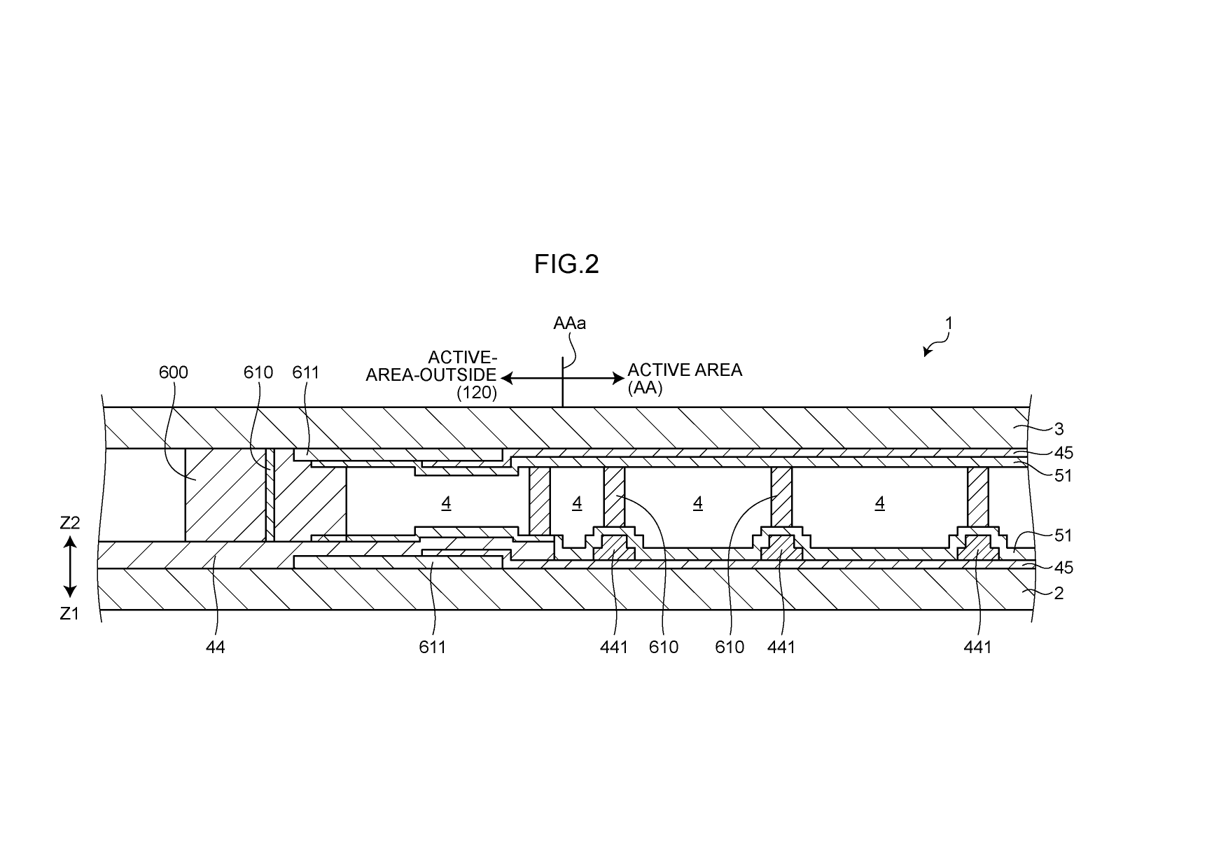

FIG. 2 is a schematic diagram illustrating a section of FIG. 1. As illustrated in FIG. 2, the light adjustment panel 1 includes the first substrate 2, the second substrate 3, a seal material 600, a light-transmitting electrode 45, an alignment film 51, an insulating layer 44, an insulating layer 441, a spacer 610, a wring line 611, and a liquid crystal layer 4.

As illustrated in FIG. 2, outside (active-area-outside 120) the active area AA, the wiring line 611 is provided on the upper side (Z2 side) relative to the first substrate 2, and the insulating layer 44 is provided on the upper side relative to the wiring line 611 and the first substrate 2. The insulating layer 44 may be, for example, an inorganic insulating layer such as silicon nitride (SiN). The alignment film 51 is provided on the upper side relative to the insulating layer 44. The alignment film 51 is made of, for example, polyimide (PI). An alignment film is provided to align liquid crystal molecules of a liquid crystal layer in a predetermined direction (initial alignment direction) when no electric field is applied, and the initial alignment direction is obtained by performing rubbing treatment or photo-alignment treatment on the alignment film.

Outside the active area AA, the wiring line 611 is provided on the lower side (Z1 side) relative to the second substrate 3, and the alignment film 51 is provided on the lower side relative to the wiring line 611. The seal material 600 is provided between the first substrate 2 and the second substrate 3. The spacer 610 is provided on the inner side relative to the seal material 600. A space between the first substrate 2 and the second substrate 3 on the inner side relative to the seal material 600 is filled with the liquid crystal layer 4.

In the active area AA, the light-transmitting electrode 45 is provided on the upper side relative to the first substrate 2. The light-transmitting electrode 45 is, for example, a light-transmitting conductive material such as indium tin oxide (ITO). In the active area AA, a plurality of the spacers 610 are provided between the first substrate 2 and the second substrate 3. The spacers 610 may be, for example, a photo-spacer (PS material) provided in a photolithography process or a metal film. The insulating layer 441 and the alignment film 51 are provided between the lower end of the spacers 610 and the light-transmitting electrode 45. Specifically, the insulating layer 441 is provided on the upper side relative to the light-transmitting electrode 45, and the alignment film 51 is provided on the upper side relative to the insulating layer 441. The alignment film 51 is provided across substantially the entire area of the active area AA in addition to the upper side of the insulating layer 441. The insulating layer 441 may be, for example, an inorganic insulating layer such as silicon nitride (SiN) or silicon oxide (SiO). The insulating layer 441 may be formed by stacking a silicon nitride layer and a silicon oxide layer. The insulating layer 441 may be formed of the same material as the insulating layer 44 formed outside the active area AA.

In the active area AA, the light-transmitting electrode 45 is provided on the lower side relative to the second substrate 3, and the alignment film 51 is provided on the lower side relative to the light-transmitting electrode 45.

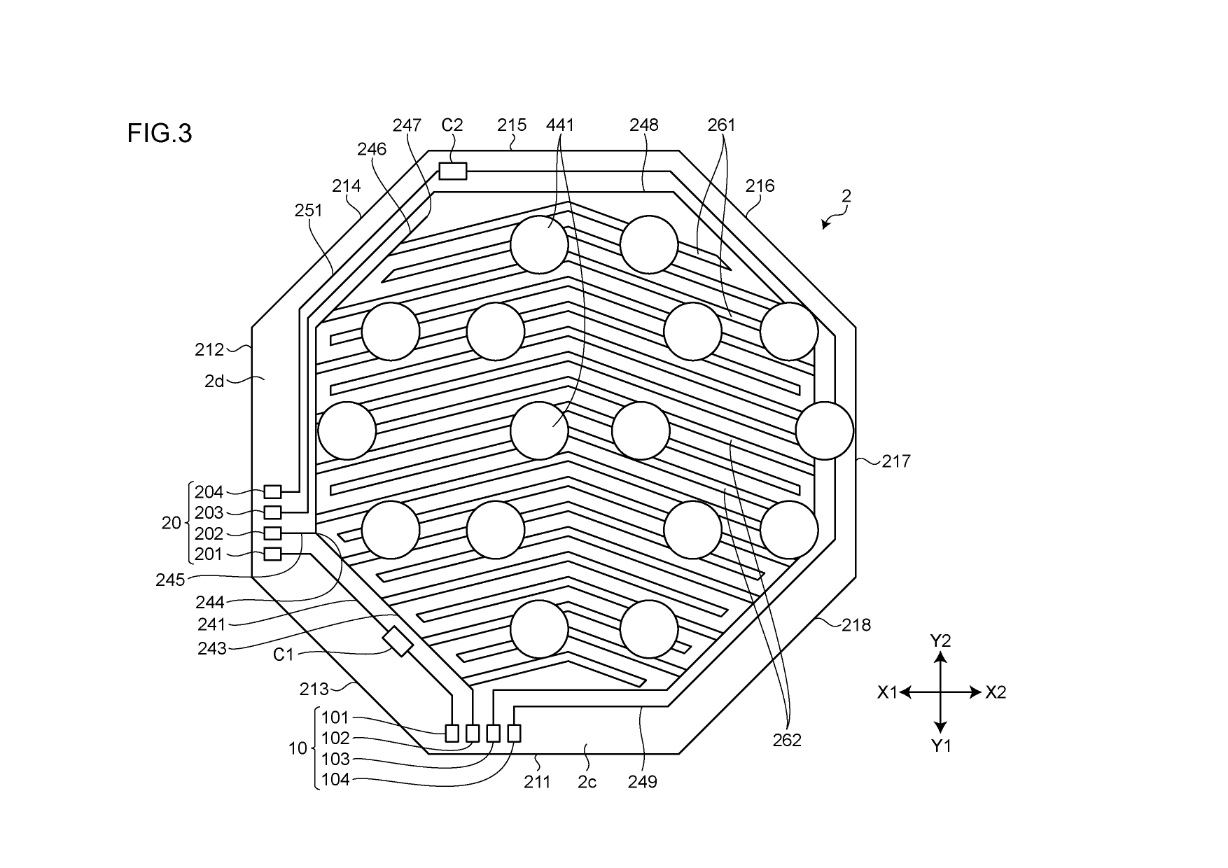

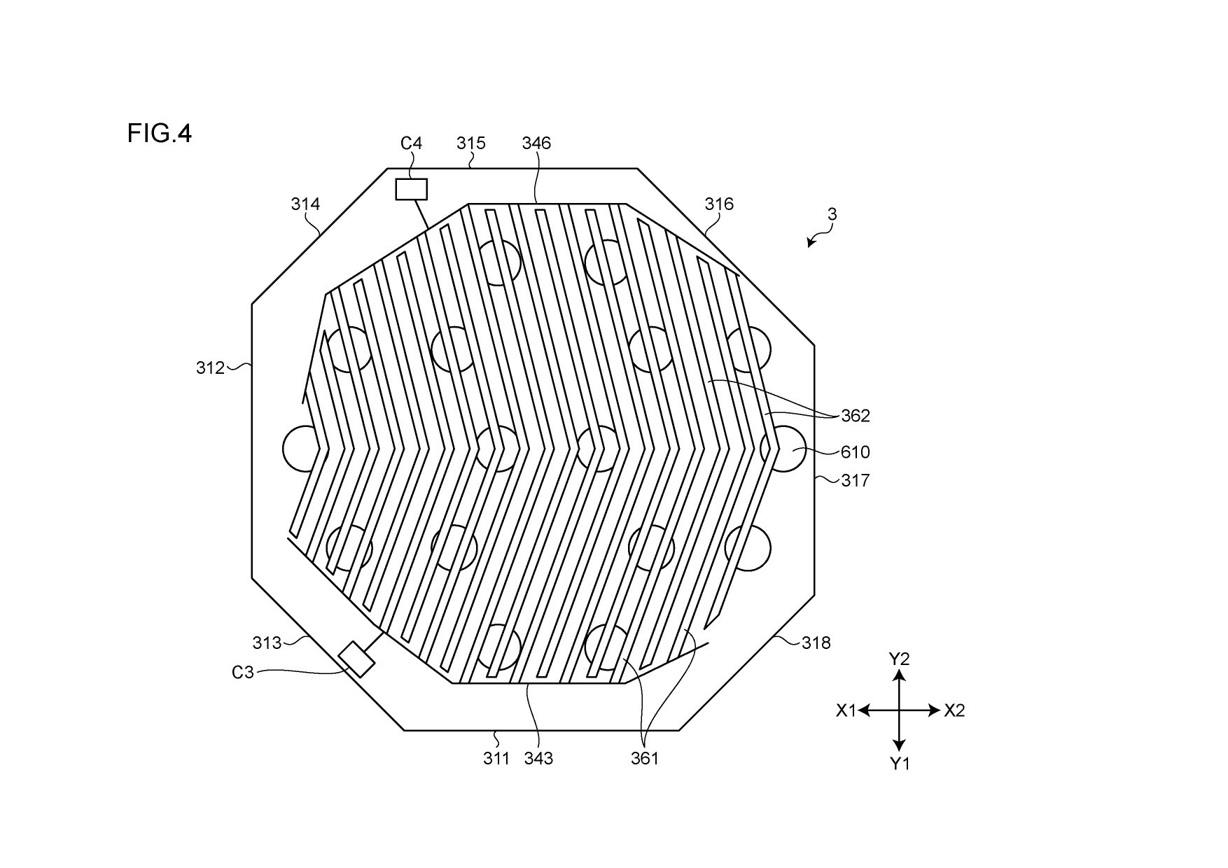

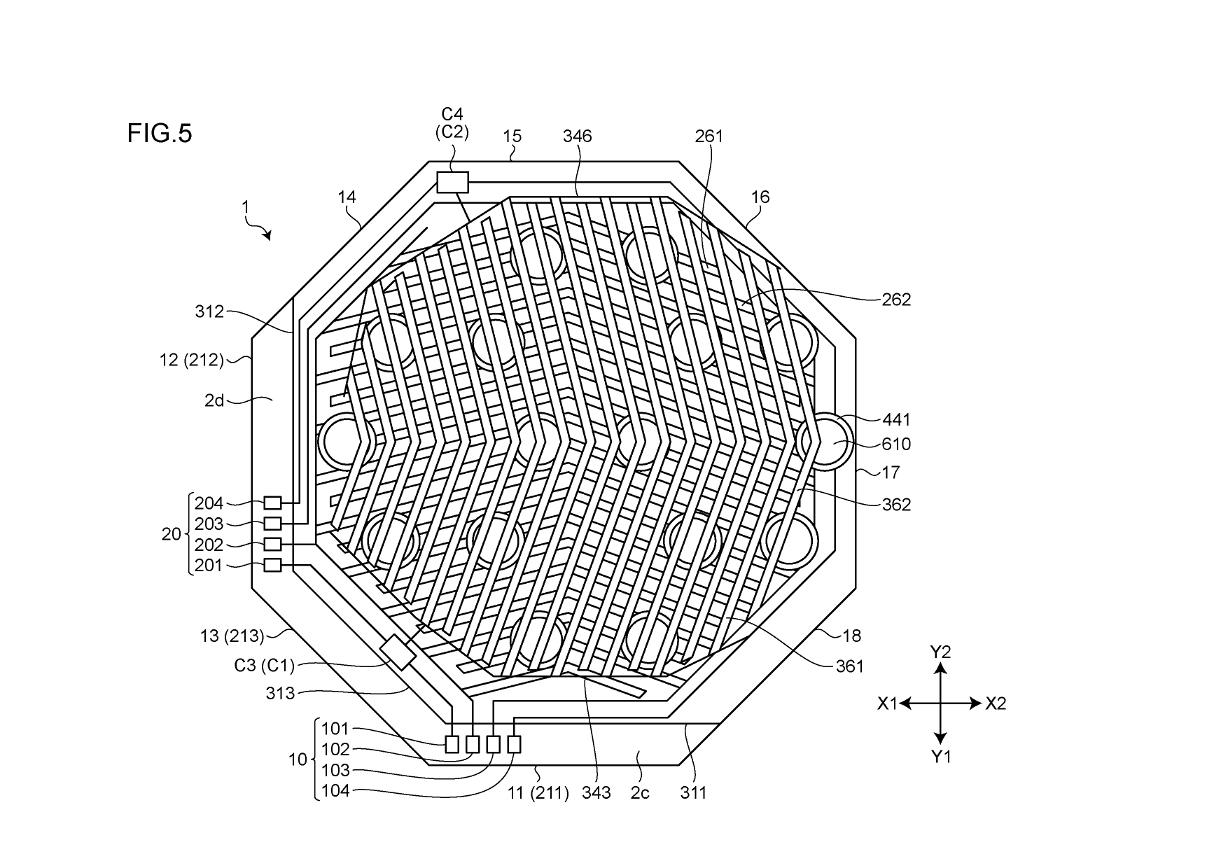

The following describes wiring on the first substrate 2 and the second substrate 3. FIG. 3 is a plan view of the first substrate according to the first embodiment. FIG. 4 is a plan view of the second substrate according to the first embodiment. In FIG. 4, electrodes are positioned below the second substrate 3, but for clarity, the electrodes and wiring are illustrated with solid lines. FIG. 5 is a plan view of a light adjustment panel obtained by placing the second substrate in FIG. 4 on the upper side of the first substrate in FIG. 3.

As illustrated in FIG. 3, wiring, drive electrodes, and coupling parts are provided on the first substrate 2. A coupling part C1 of the first substrate 2 and a coupling part C3 of the second substrate 3 (refer to FIG. 4) are electrically coupled to each other through a conductive member (not illustrated). Similarly, a coupling part C2 of the first substrate 2 and a coupling part C4 of the second substrate 3 (refer to FIG. 4) are electrically coupled to each other through a conductive member (not illustrated).

The first substrate 2 is an octagon in plan view and includes a first side 211, a second side 212, a third side 213, a fourth side 214, a fifth side 215, a sixth side 216, a seventh side 217, and an eighth side 218.

The first terminal group 10 includes a first terminal 101, a second terminal 102, a third terminal 103, and a fourth terminal 104. The first terminal 101, the second terminal 102, the third terminal 103, and the fourth terminal 104 are sequentially arranged in the X direction from the X1 side toward the X2 side.

The second terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are sequentially arranged in the Y direction from the Y1 side toward the Y2 side.

The first terminal 101 and the fifth terminal 201 are electrically coupled to each other through a wiring line 241. The coupling part C1 is provided at an intermediate point of the wiring line 241.

The second terminal 102 and the sixth terminal 202 are electrically coupled to each other through wiring lines 243 and 245. A bifurcation point 244 is provided on the wiring line 243, and a wiring line 246 extends from the bifurcation point 244 to an end 247.

The third terminal 103 and the seventh terminal 203 are electrically coupled to each other through a wiring line 248. The fourth terminal 104 and the eighth terminal 204 are electrically coupled to each other through wiring lines (fourth wiring lines) 249 and 251. The coupling part C2 is provided between the wiring lines 249 and 251.

A plurality of drive electrodes (first electrodes) 261 are coupled to the wiring lines 243 and 246. A plurality of drive electrodes (first electrodes) 262 are coupled to the wiring line 248. The drive electrodes 261 and 262 both extend in the X direction. Specifically, the drive electrodes 261 and 262 bend in a V shape protruding toward the Y2 side. The drive electrodes 261 and 262 are alternately arranged in the Y direction. A plurality of the insulating layers 441 are disposed on the upper side relative to the drive electrodes 261 and 262. The insulating layers 441 are circular in plan view. As illustrated in FIGS. 3 and 5, each insulating layer 441 has a circular shape that is the same as or slightly larger than the outer shape of the corresponding spacer 610, and overlaps the drive electrodes 261 and 262 adjacent to each other. The insulating layers 441 may be provided covering straight parts of the drive electrodes 261 and 262 or may be provided covering bent parts of the drive electrodes 261 and 262.

As illustrated in FIG. 4, wiring, drive electrodes, and coupling parts are provided on the second substrate 3. The second substrate 3 is an octagon in plan view and has a first side 311, a second side 312, a third side 313, a fourth side 314, a fifth side 315, a sixth side 316, a seventh side 317, and an eighth side 318.

The coupling part C3 is coupled to a wiring line 343. The coupling part C4 is coupled to a wiring line 346. The wiring line 343 extends along the first side 311, the third side 313, and the eighth side 318. The wiring line 346 extends along the fourth side 314, the fifth side 315, and the sixth side 316.

A plurality of drive electrodes (second electrodes) 361 are coupled to the wiring line 343. A plurality of drive electrodes (second electrodes) 362 are coupled to the wiring line 346. The drive electrodes 361 and 362 both extend in the Y direction. Specifically, the drive electrodes 361 and 362 bend in a V shape protruding toward the X2 side. The drive electrodes 361 and 362 are alternately arranged in the X direction. The spacers 610 are disposed on the lower side relative to the drive electrodes 361 and 362. The spacers 610 are circular in plan view.

As illustrated in FIG. 5, in the light adjustment panel 1 obtained by placing the second substrate 3 in FIG. 4 on the upper side of the first substrate 2 in FIG. 3, the end parts 2c and 2d of the first substrate 2 are exposed. In a state in which the second substrate 3 is placed on the upper side of the first substrate 2, the first side 311, the third side 313, and the second side 312 of the second substrate 3 are positioned on the inner side (at a central part in plan view) relative to the first side 211, the third side 213, and the second side 212 of the first substrate 2. In this manner, the area of the second substrate 3 is smaller than the area of the first substrate 2, and accordingly, in FIG. 5, the first terminal group 10 provided at the end part 2c of the first substrate 2 and the second terminal group 20 provided at the end part 2d are exposed.

As illustrated in FIG. 5, the drive electrodes 361 and 362 are disposed so as to intersect the drive electrodes 261 and 262. The spacers 610 and the insulating layers 441 are both circular in plan view. The insulating layers 441 and the spacers 610 overlap when viewed along the Z direction (first direction). Since the insulating layers 441 are larger than the spacers 610, the outer periphery of each insulating layer 441 is positioned outside the outer periphery of the corresponding spacer 610 in FIG. 5.

The following describes the active area (effective region) AA. As illustrated in FIG. 5, in the light adjustment panel 1, the drive electrodes 261 and 262 on the first substrate 2 intersect the drive electrodes 361 and 362 on the second substrate 3 in plan view. The alignment direction of the liquid crystal molecules in the liquid crystal layer 4 can be controlled by supplying drive voltage to the drive electrodes 261 and 262 and the drive electrodes 361 and 362. A region in which the alignment direction of the liquid crystal molecules in the liquid crystal layer 4 can be controlled is referred to as the "active area AA". The refractive index distribution of the liquid crystal layer 4 is changed in the active area AA, whereby the diffusion degree of light passing through the active area AA of the light adjustment panel 1 can be controlled. Thus, the active area AA can be referred to as a "diffusion degree control effective region" in which the diffusion degree of passing light can be controlled. In FIG. 5, the initial alignment direction of the alignment film 51 on the first substrate 2 side is formed from the Y1 direction toward the Y2 direction, and the initial alignment direction of the alignment film 51 on the second substrate 3 side is formed from the X1 direction toward the X2 direction. Thus, the initial alignment directions of the liquid crystal molecules in the liquid crystal layer 4 (long-axis direction of the liquid crystal molecules) gradually rotates, from the first substrate 2 side toward the second substrate 3 side, and finally rotates by 90°. When an electric field is generated between adjacent electrodes of the substrates, the liquid crystal molecules, which are aligned along the initial alignment directions in the initial state, rotate their directions from the initial alignment directions in accordance with the electric field direction, whereby a refractive index distribution of light is generated in the liquid crystal layer 4. The initial alignment direction at the first substrate 2 is different from the initial alignment direction at the second substrate 3 by 90°, but the present disclosure is not limited to 90°, and the angle is changeable as appropriate within the range of 80° to 90°.

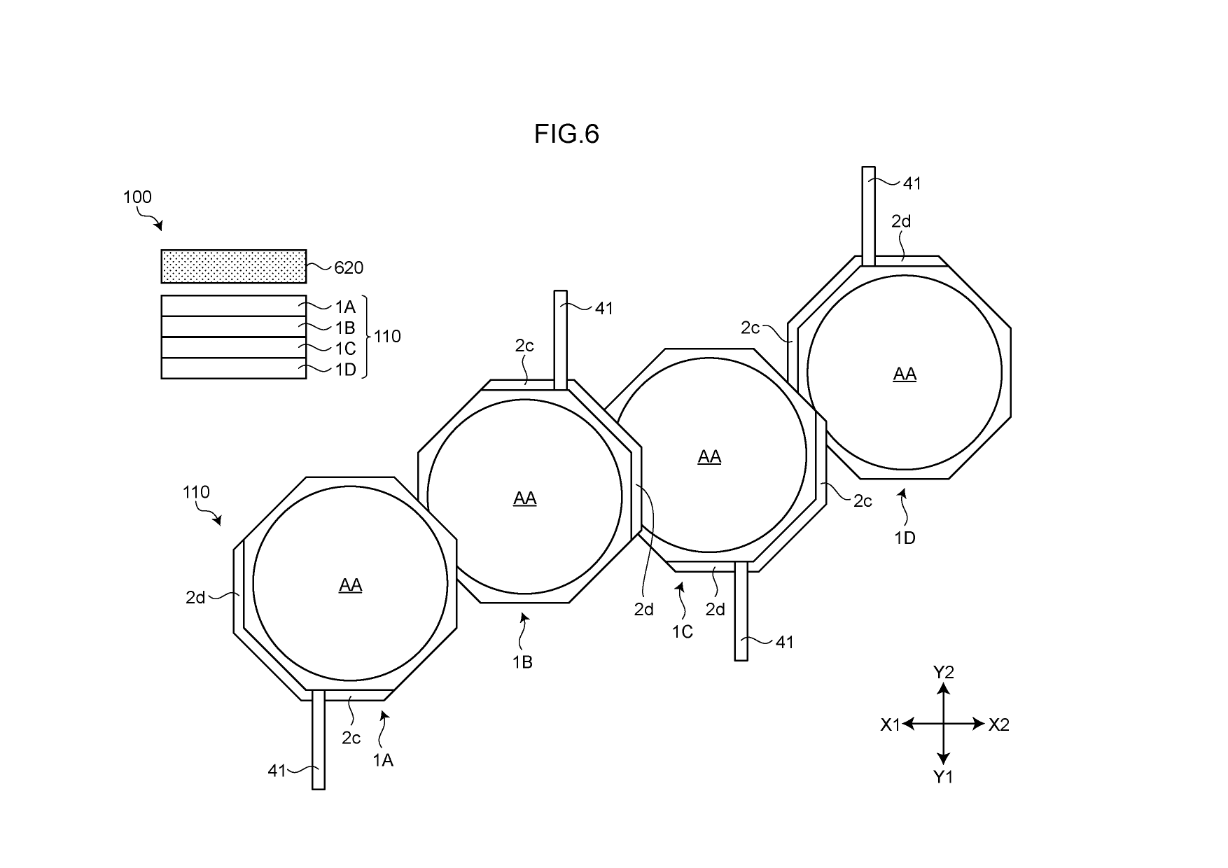

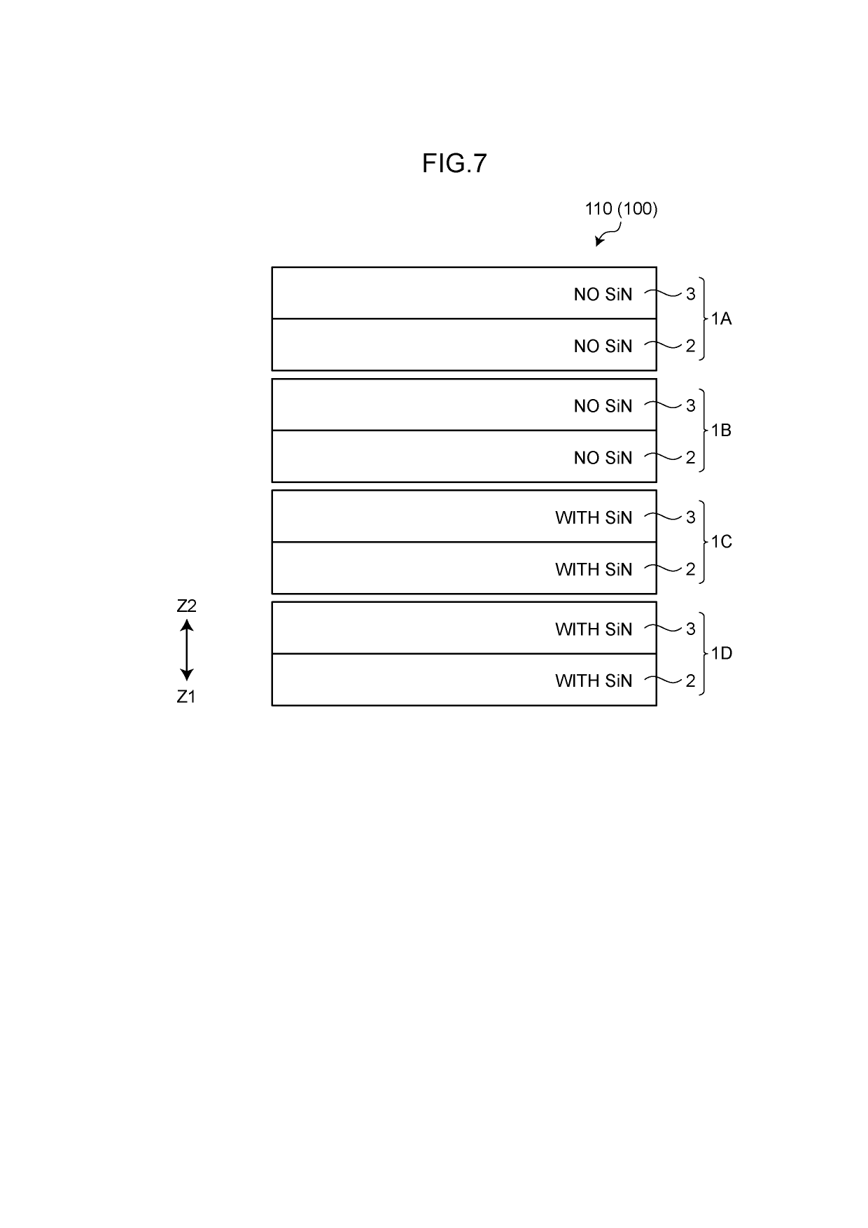

The following briefly describes the configuration of a light adjustment device 100 according to the first embodiment. FIG. 6 is a schematic diagram of four light adjustment panels constituting the light adjustment device according to the first embodiment. FIG. 7 is a schematic diagram illustrating a section of the light adjustment device according to the first embodiment.

As illustrated in FIGS. 6 and 7, the light adjustment device 100 includes a light source 620 and a panel unit 110. The light source 620 is positioned on the upper side (Z2 side) relative to the panel unit 110. In the panel unit 110, a first light adjustment panel 1A, a second light adjustment panel 1B, a third light adjustment panel 1C, and a fourth light adjustment panel 1D are stacked in this order from the upper side. The number of light adjustment panels 1 included in the light adjustment device 100 is not limited to four but may be two or more.

As illustrated in FIG. 6, in the first light adjustment panel 1A, the first terminal group 10 (refer to FIG. 5) provided at the end part 2c of the first substrate 2 is positioned on the Y1 side and electrically coupled to a flexible printed circuit board 41. The second light adjustment panel 1B is obtained by rotating the first light adjustment panel 1A by 180° in plan view. Accordingly, the first terminal group 10 is positioned on the Y2 side and electrically coupled to a flexible printed circuit board 41.

The third light adjustment panel 1C is obtained by rotating the first light adjustment panel 1A by 90° in the counterclockwise direction in plan view, and the second terminal group 20 provided at the end part 2d is positioned on the Y1 side and electrically coupled to the flexible printed circuit board 41. The fourth light adjustment panel 1D is obtained by rotating the first light adjustment panel 1A by 90° in the clockwise direction in plan view, and the second terminal group 20 provided at the end part 2d is positioned on the Y2 side and electrically coupled to a flexible printed circuit board 41.

As illustrated in FIG. 7, in the present embodiment, the circular insulating layers 441 illustrated in FIG. 5 are provided in two of the four light adjustment panels 1. Specifically, no insulating layers 441 are provided in the first light adjustment panel 1A or the second light adjustment panel 1B. In each of the third light adjustment panel 1C and the fourth light adjustment panel 1D, the insulating layers 441 are provided on both the first substrate 2 and the second substrate 3. For example, light adjustment panels 1 in which the insulating layers 441 are provided can be used as S-wave polarization light adjustment panels 1, and light adjustment panels 1 in which the insulating layers 441 are not provided can be used as P-wave polarization light adjustment panels 1, but for example, light adjustment panels 1 in which the insulating layers 441 are provided may be used as P-wave polarization light adjustment panels 1, and light adjustment panels 1 in which the insulating layers 441 are not provided may be used as S-wave polarization light adjustment panels 1.

In the present invention, it is sufficient to provide the insulating layers 441 in at least one of the four light adjustment panels 1. For example, the insulating layers 441 may be provided only in the fourth light adjustment panel 1D but not in the other the light adjustment panels 1. In other applicable aspects, the insulating layers 441 may be provided in the first light adjustment panel 1A and the third light adjustment panel 1C but may not be provided in the second light adjustment panel 1B or the fourth light adjustment panel 1D, or the insulating layers 441 may not be provided in the first light adjustment panel 1A or the third light adjustment panel 1C but may be provided in the second light adjustment panel 1B and the fourth light adjustment panel 1D. Alternatively, the insulating layers 441 may be provided on both the first substrate 2 and the second substrate 3 in each of the four light adjustment panels 1.

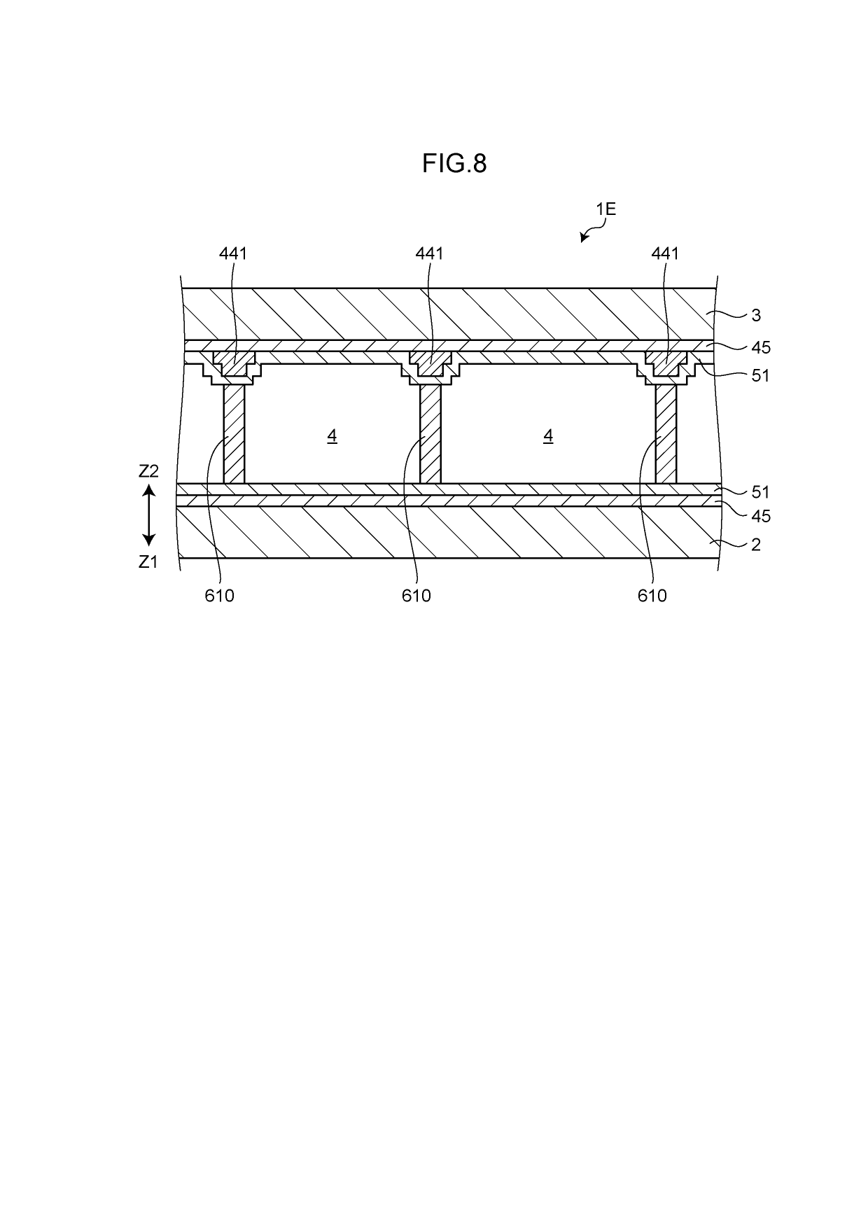

FIG. 8 is a sectional view of a light adjustment panel according to a modification of the first embodiment. In the above-described embodiment, the circular insulating layers 441 are provided on the first substrate 2 as illustrated in FIG. 2, but in a light adjustment panel 1E as illustrated in FIG. 8, the circular insulating layers 441 may be provided on the second substrate 3. Although not illustrated, the insulating layers 441 may be provided on both the first substrate 2 and the second substrate 3.

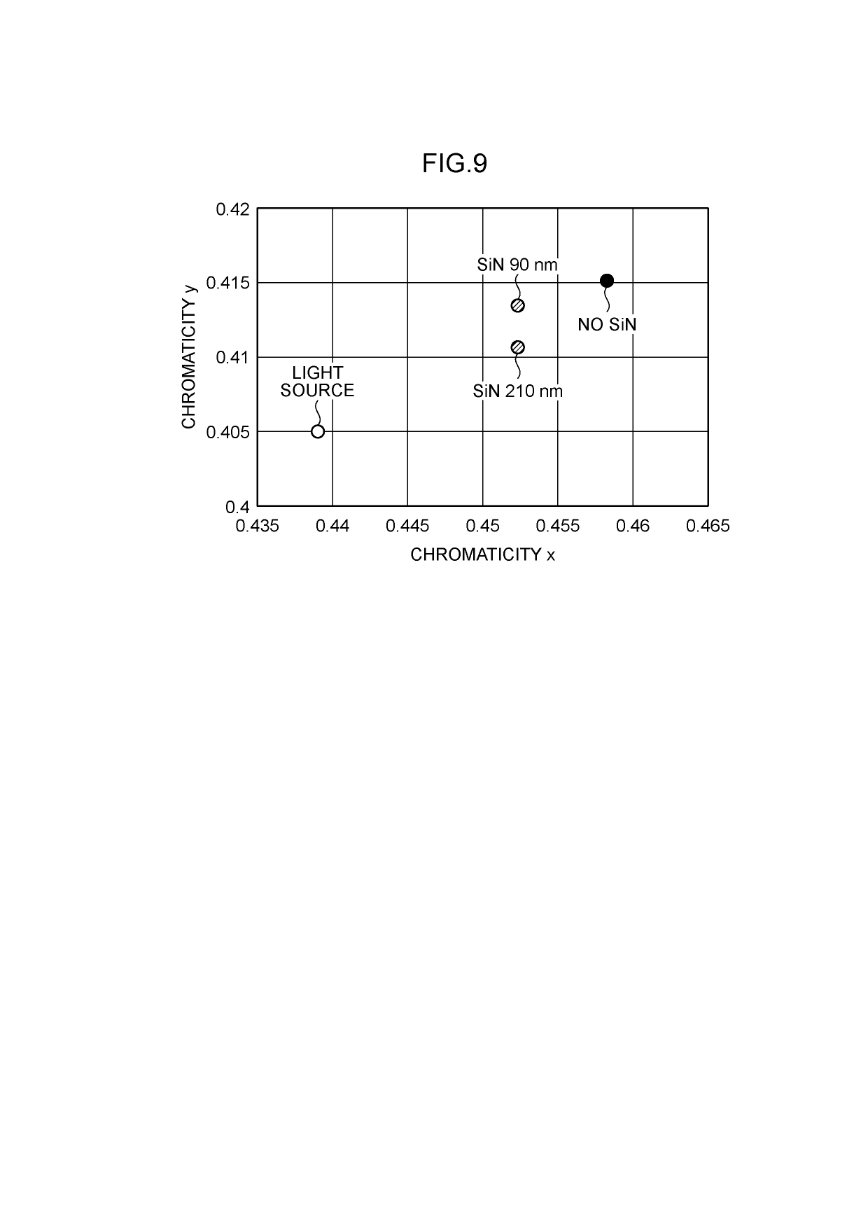

FIG. 9 is a graph illustrating chromaticity in a case where an insulating layer is disposed across the entire active area unlike FIG. 8, and in a case where no insulating layer is disposed in the active area. Specifically, FIG. 9 is a result of irradiating the panel unit 110, in which the four light adjustment panels 1 are stacked as illustrated in FIG. 6, with light from the light source 620, and measuring chromaticity of light having passed through the panel unit 110.

In FIG. 9, "no SiN" indicates chromaticity in a case where no insulating layers 441 are formed in any of the active areas AA of the four light adjustment panels 1. "SiN 90nm" indicates chromaticity of light having passed through the panel unit 110 in which the four light adjustment panels 1 are stacked, each formed with the insulating layers 441 of SiN having a thickness of 90nm across the entire active area AA on each of the first substrate 2 and the second substrate 3 constituting the light adjustment panel 1. Similarly, "SiN 210nm" indicates chromaticity of light having passed through the panel unit 110 in which the four light adjustment panels 1 are stacked, each formed with the insulating layers 441 of SiN having a thickness of 210nm across the entire active area AA on each of the first substrate 2 and the second substrate 3 constituting the light adjustment panel 1.

From FIG. 9, it is understood that, in a case where the insulating layers 441 are formed in the active area, decrease in color temperature (that is, shift from white to yellow) is reduced as compared to a case where no insulating layers 441 are formed therein, and color is closer to chromaticity of the light source 620.

As described above, in the light adjustment device 100 according to the first embodiment, at least one of the light adjustment panels 1 includes the first substrate 2, the second substrate 3, the liquid crystal layer 4, the drive electrodes 261, 262, 361, and 362, and the insulating layers 441 containing SiN or SiO. The insulating layers 441 are stacked on at least one of the first substrate 2 or the second substrate 3 and provided in the active area AA.

As described above, in a conventional light adjustment device, in order to reduce decrease in the transmittance of emitted light, no insulating layer such as SiN is provided in an active area provided with a liquid crystal layer, and accordingly, the color temperature of emitted light potentially decreases.

However, in the present embodiment, at least one of the first substrate 2 or the second substrate 3 is provided with the insulating layers 441 in the active area AA. As described above with reference to FIG. 9, the chromaticity of emitted light decreases and becomes closer to the color temperature of the light source when an insulating layer such as SiN is provided. In this manner, according to the present embodiment, decrease in the color temperature of light emitted from the light adjustment device 100 can be reduced as compared to a case where no insulating layer such as SiN is provided in an active area. On the other hand, providing the insulating layers 441 leads to decrease in the transmittance of light in the light adjustment panel 1. Thus, the insulating layers 441 are distributed in the active area AA as in the present embodiment, suppression of coloration and decrease in transmittance in the light adjustment panel 1 are adjusted.

In the active area AA, the spacers 610 are provided between the first substrate 2 and the second substrate 3. The spacers 610 and the insulating layers 441 overlap when viewed along the Z direction.

Depending on the installation place and usage aspect of the light adjustment device 100 of the present embodiment, the light adjustment panels 1 are exposed to a high-temperature and high-humidity condition for a long time, and as a result, the alignment film 51 may peel off particularly under the spacers 610, and the spacers 610 may further scrape the drive electrodes to cause disconnection. In the present embodiment, since the high-resistance insulating layers 441 are provided between the spacers 610 and the drive electrodes, reliability against disconnection and the like is improved.

### Second Embodiment

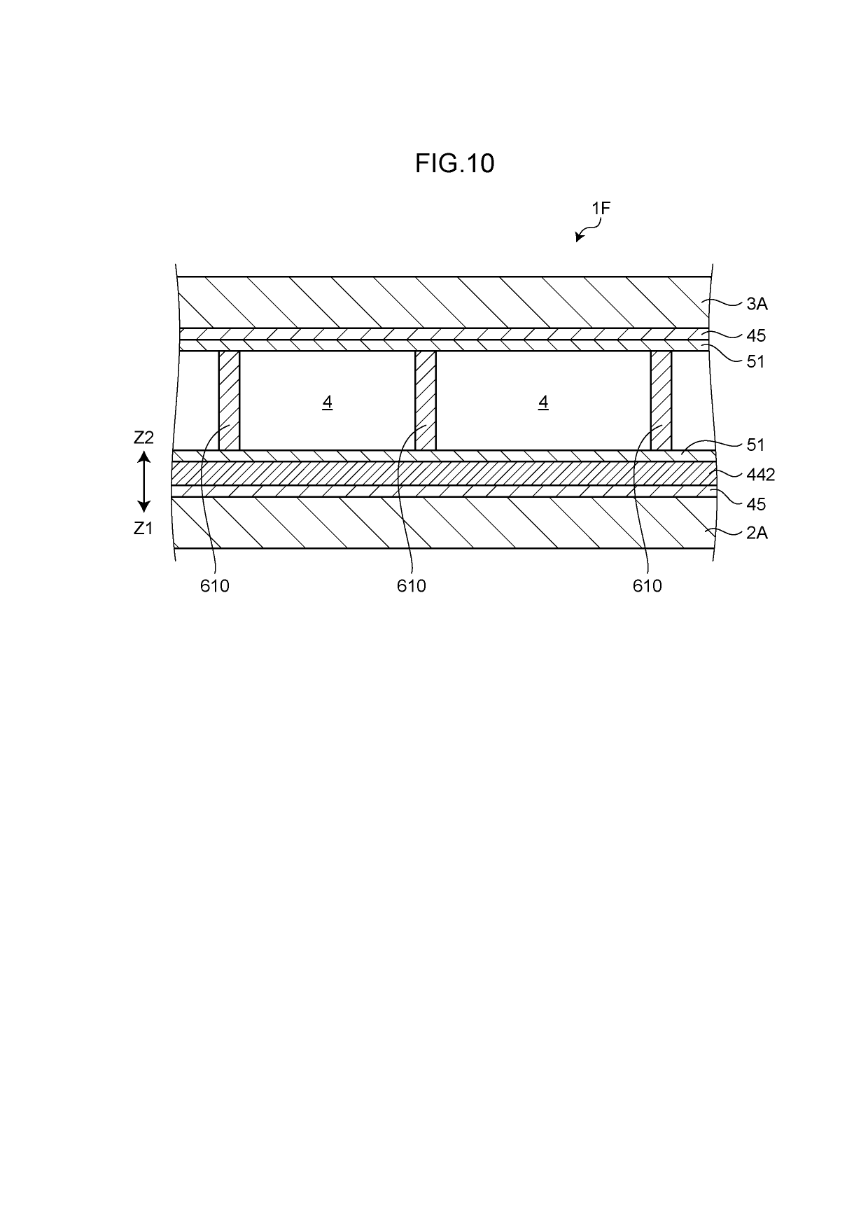

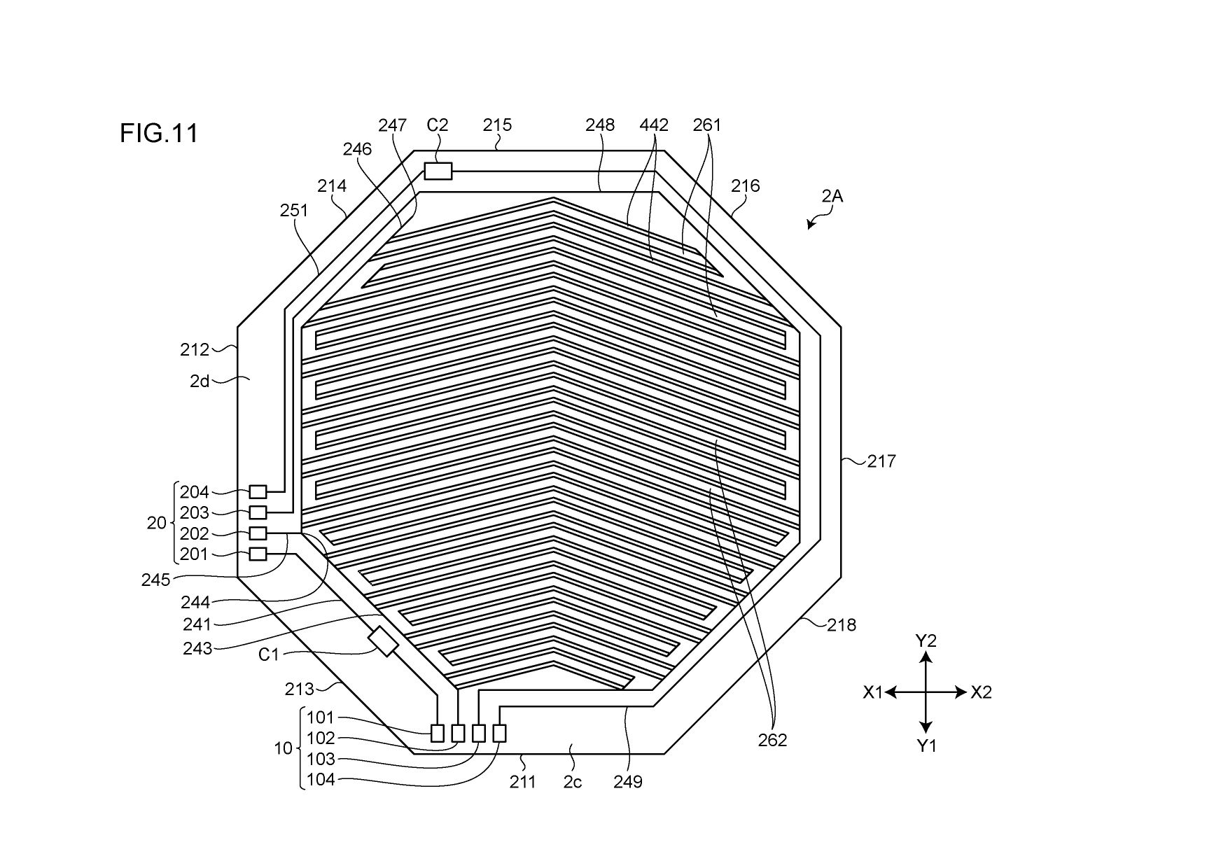

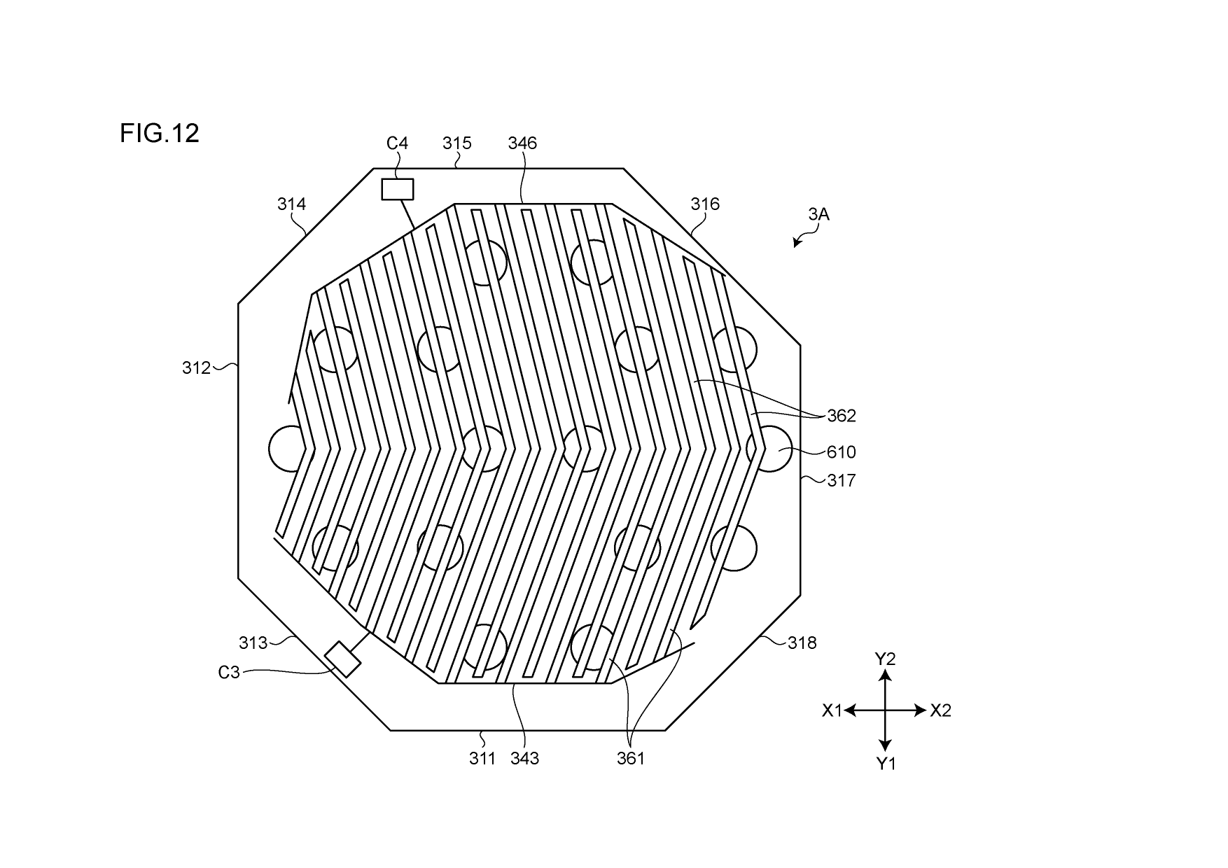

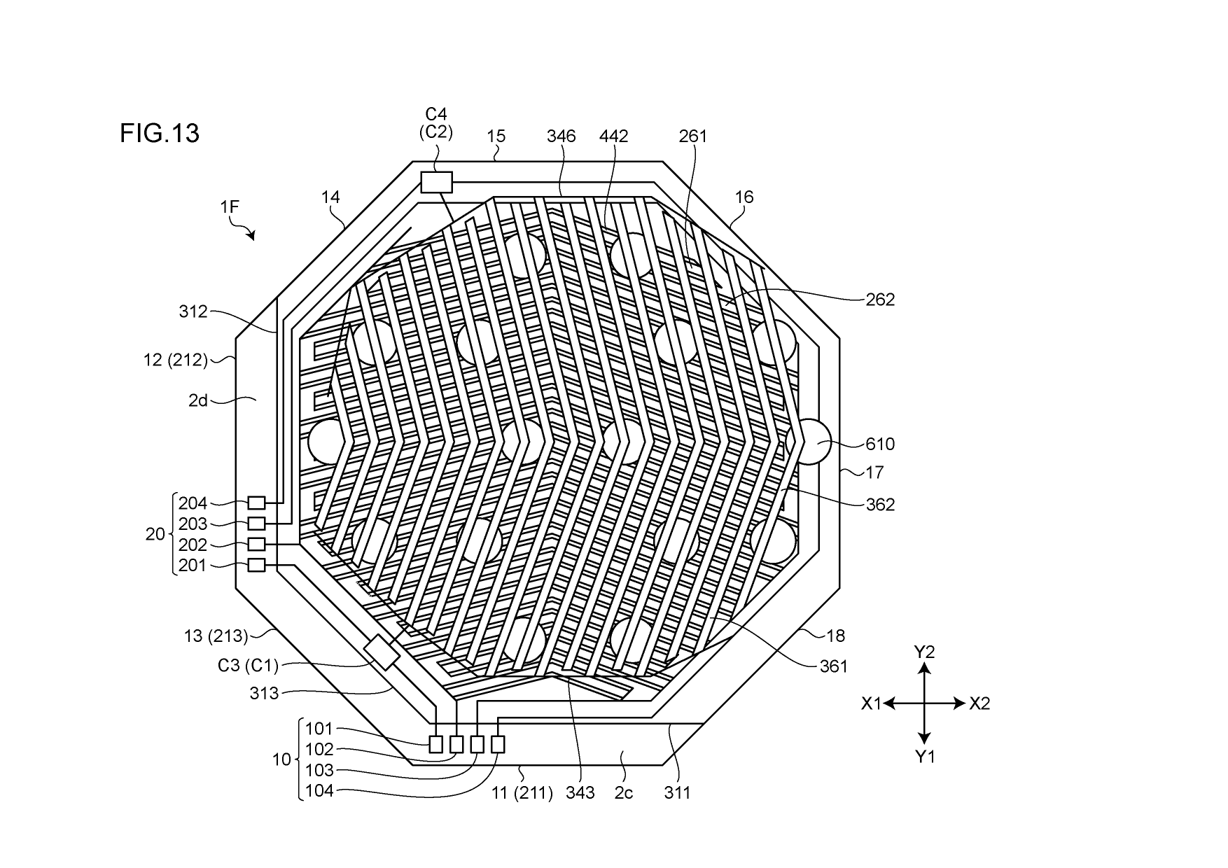

The following describes a second embodiment. FIG. 10 is a sectional view of a light adjustment panel according to the second embodiment. FIG. 11 is a plan view of a first substrate according to the second embodiment. FIG. 12 is a plan view of a second substrate according to the second embodiment. FIG. 13 is a plan view of a light adjustment panel obtained by placing the second substrate in FIG. 12 on the upper side of the first substrate in FIG. 11.

In the first embodiment, the circular insulating layers 441 are provided at positions overlapping the circular spacers 610 when viewed along the Z direction. In the second embodiment, on a first substrate 2A, insulating layers 442 stacked on the upper side relative to the drive electrodes 261 and 262 as illustrated in FIG. 11. The specific description thereof is given below.

As illustrated in FIGS. 10 and 12, in a light adjustment panel 1F according to the second embodiment, a second substrate 3A is identical to the second substrate 3 according to the first embodiment.

As illustrated in FIG. 10, in the active area AA, the light-transmitting electrode 45 is provided on the upper side relative to the first substrate 2A, and the insulating layers 442 is stacked on the upper side relative to the light-transmitting electrode 45. More specifically, as illustrated in FIGS. 11 and 13, the insulating layers 442 are stacked on the upper side relative to the drive electrodes 261 and 262 (light-transmitting electrode 45). The insulating layers 442 have elongated shapes along the drive electrodes 261 and 262, and have substantially V shapes in plan view. As illustrated in FIG. 11, the widths of the insulating layers 442 are slightly larger than the widths of the drive electrodes 261 and 262. A region in which no insulating layers 442 are provided is provided between the electrodes adjacent to each other. In the second embodiment, for example, the insulating layers 442 are stacked on the upper side relative to all drive electrodes 261 and 262 on the first substrate 2A, but in the present disclosure, the insulating layers 442 may be stacked on some of the drive electrodes 261 and 262.

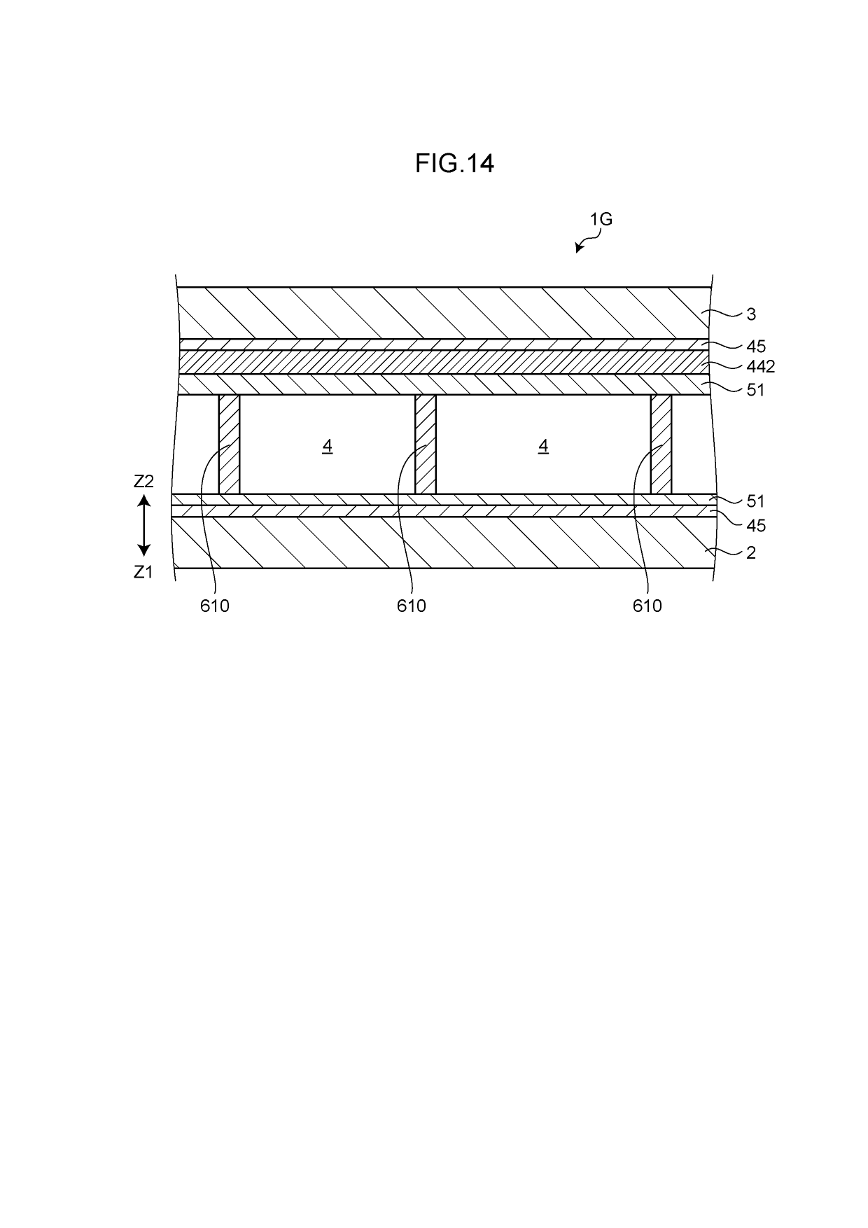

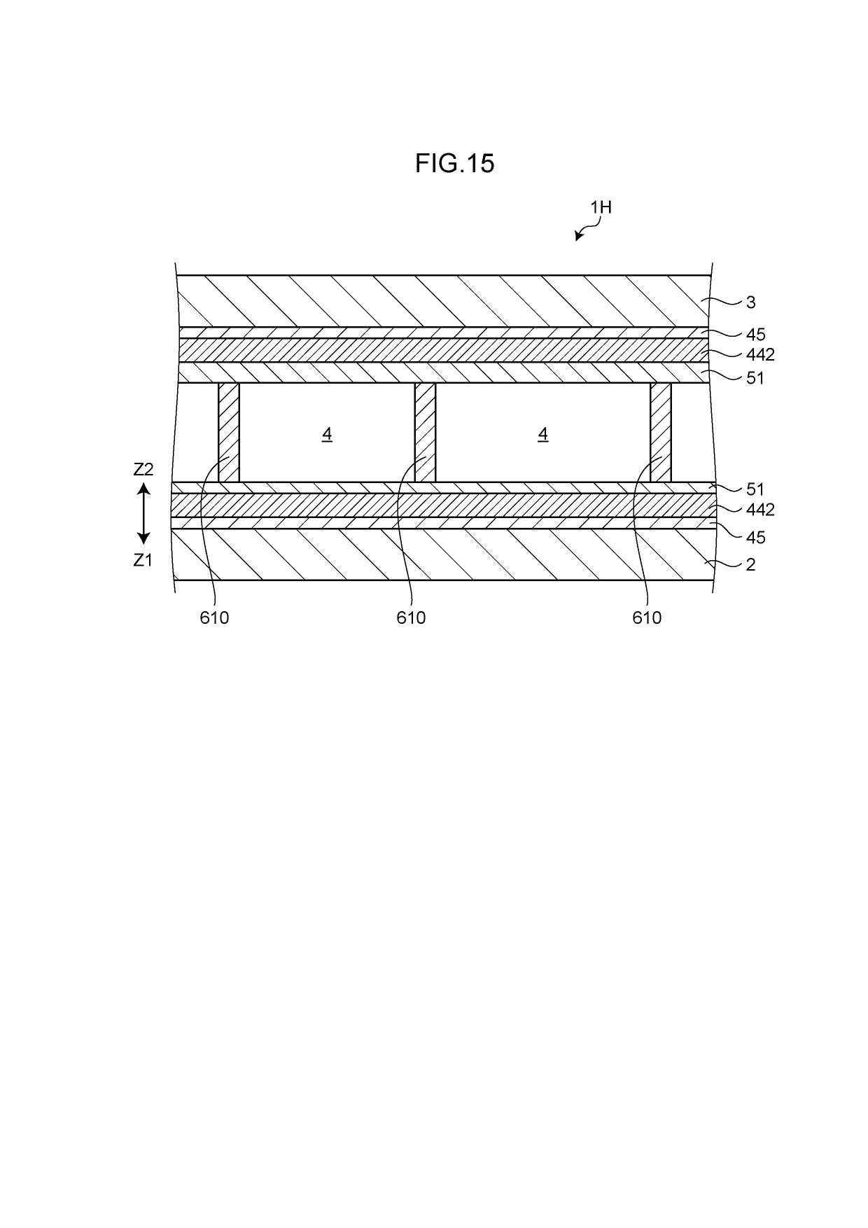

FIG. 14 is a sectional view of a light adjustment panel according to a modification of the second embodiment. FIG. 15 is a sectional view of a light adjustment panel according to another modification of the second embodiment. In the second embodiment, the insulating layers 442 are stacked on the drive electrodes 261 and 262 on the first substrate 2A as described above, the insulating layers 442 may be stacked on the drive electrodes 361 and 362 on the second substrate 3A as in a light adjustment panel 1G illustrated in FIG. 14. Alternatively, the insulating layers 442 may be stacked on the drive electrodes 261 and 262 on the first substrate 2A and the drive electrodes 361 and 362 on the second substrate 3A as in a light adjustment panel 1H illustrated in FIG. 15.

As described above, according to the second embodiment, the insulating layers 442 are stacked on, for example, the drive electrodes 261 and 262.

In a region provided with no insulating layers, yellow coloration is observed in emitted light, and thus this coloration needs to be adjusted by providing insulating layers. On the other hand, if an insulating layer is simply provided in the entire active area, the transmittance of the light adjustment panel may decrease. By providing the insulating layers 442 as in the present embodiment, coloration of emitted light is improved while decrease in transmittance is reduced.

### Third Embodiment

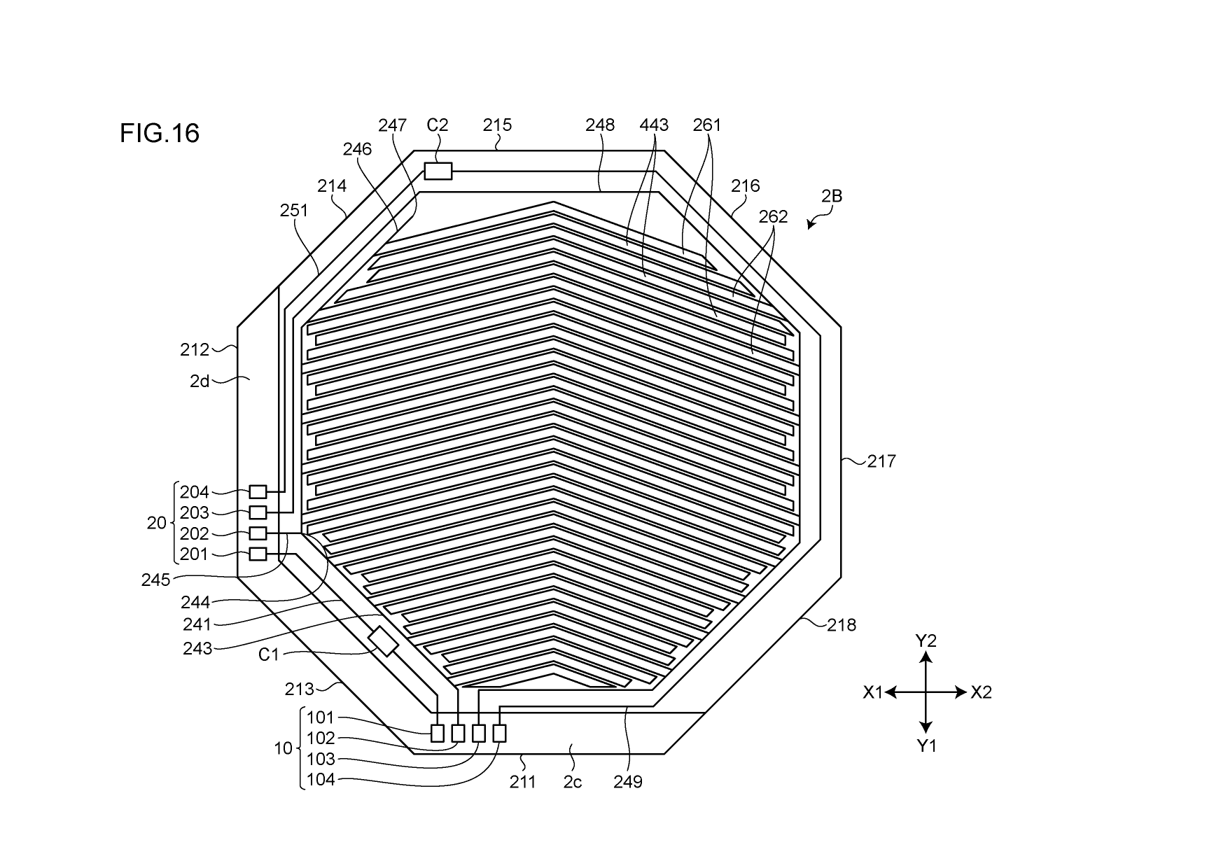

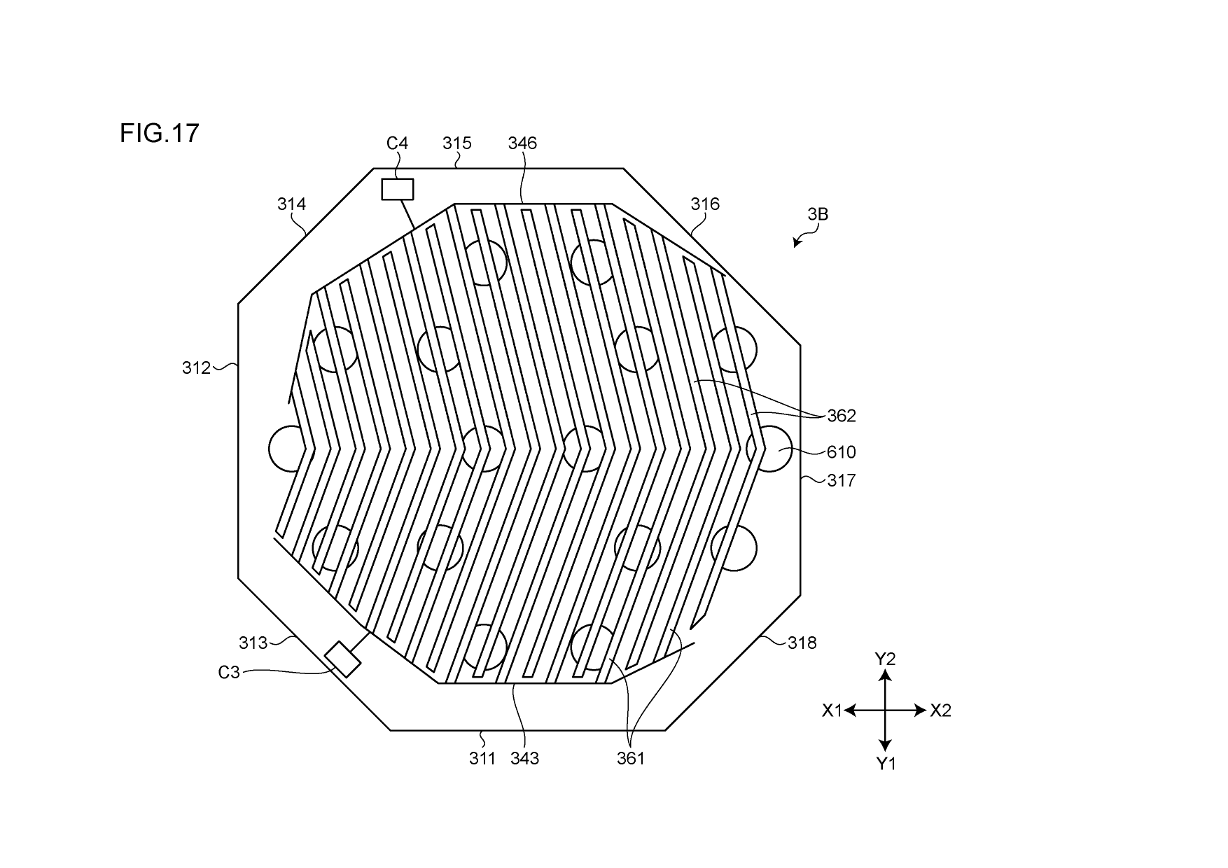

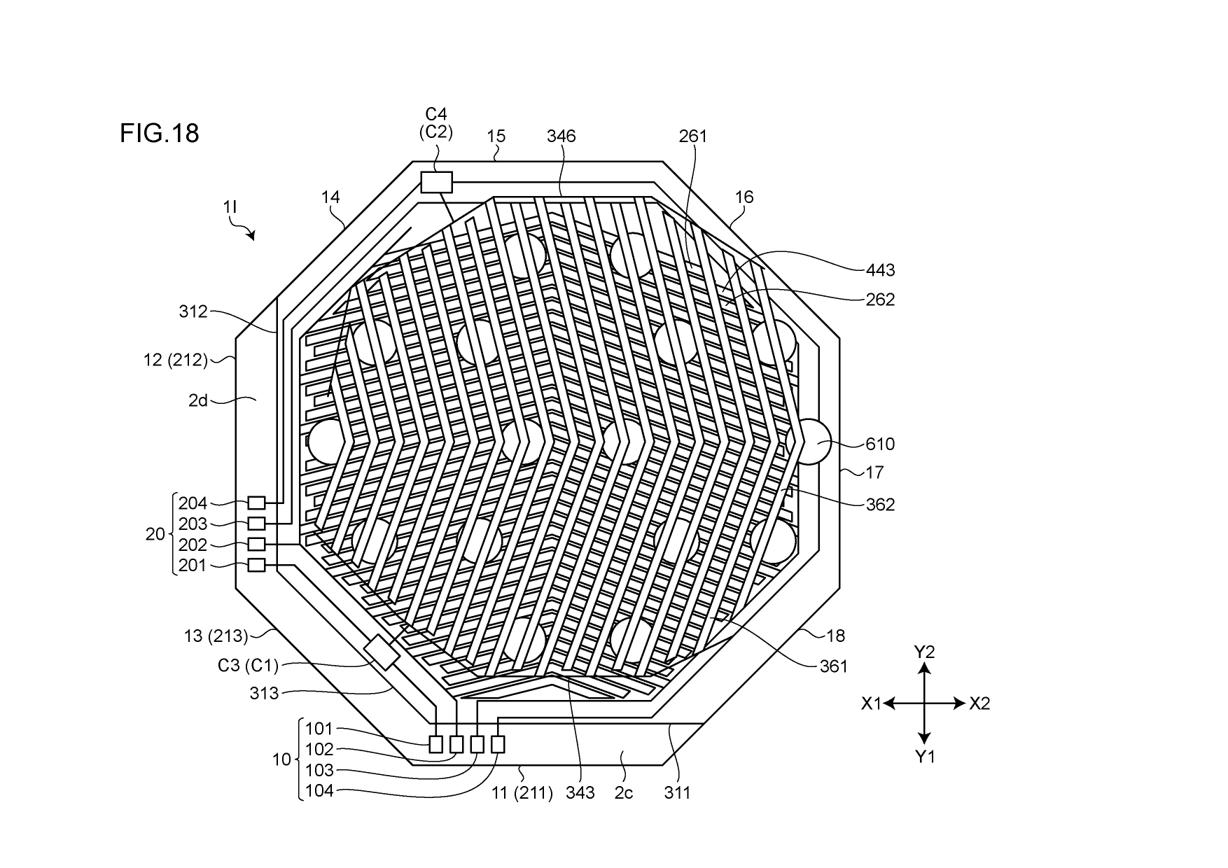

The following describes a third embodiment. FIG. 16 is a plan view of a first substrate according to the third embodiment. FIG. 17 is a plan view of a second substrate according to the third embodiment. FIG. 18 is a plan view of a light adjustment panel obtained by placing the second substrate in FIG. 17 on the upper side of the first substrate in FIG. 16. In the third embodiment, insulating layers 443 are provided between the drive electrodes 261 and 262 on a first substrate 2B. The specific description thereof is given below.

As illustrated in FIG. 17, a second substrate 3B according to the third embodiment is identical to the second substrate 3 according to the first embodiment.

As illustrated in FIGS. 16 and 18, the drive electrodes 261 and 262 are alternately disposed with gaps therebetween in the Y direction on the first substrate 2B in a light adjustment panel 1I. The insulating layers 443 are provided in gaps between the drive electrodes 261 and 262 adjacent to each other in the Y direction. The insulating layers 443 have shapes along the drive electrodes 261 and 262 and have substantially V shapes in plan view. The widths of the insulating layers 443 are substantially equal to the widths of the drive electrodes 261 and 262 adjacent to each other in the Y direction. The lengths of the insulating layers 443 are substantially equal to the lengths of the drive electrodes 261 and 262. In the third embodiment, the insulating layers 443 are provided in all gaps between the drive electrodes 261 and 262, but in the present disclosure, the insulating layers 443 may be provided in some of the gaps between the drive electrodes 261 and 262. The insulating layers 443 may be provided on the second substrate 3B, instead of providing the insulating layers 443 on the first substrate 2B.

As described above, according to the third embodiment, the insulating layers 443 are provided in gaps between the drive electrodes 261 and 262 adjacent to each other.

In this case, as in the second embodiment, coloration of emitted light is improved while decrease in transmittance is reduced.

### Fourth Embodiment

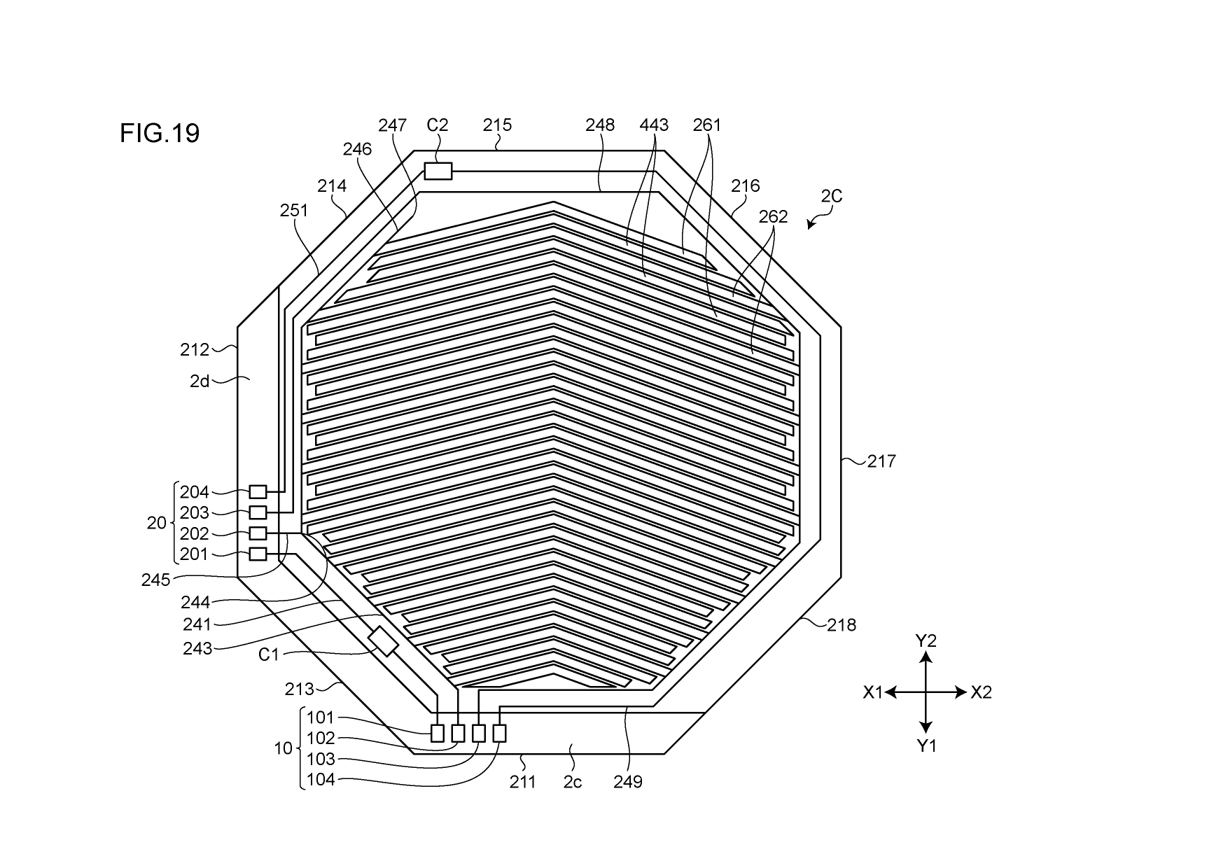

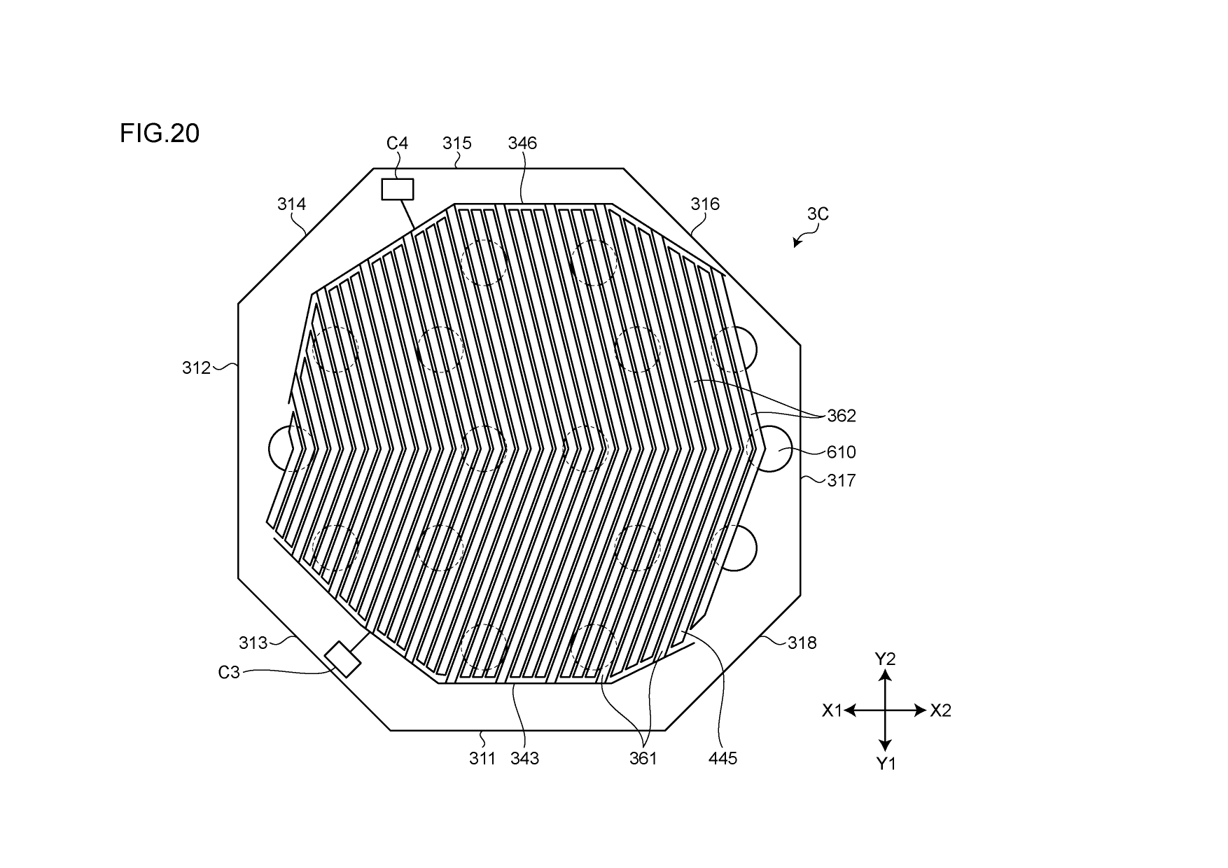

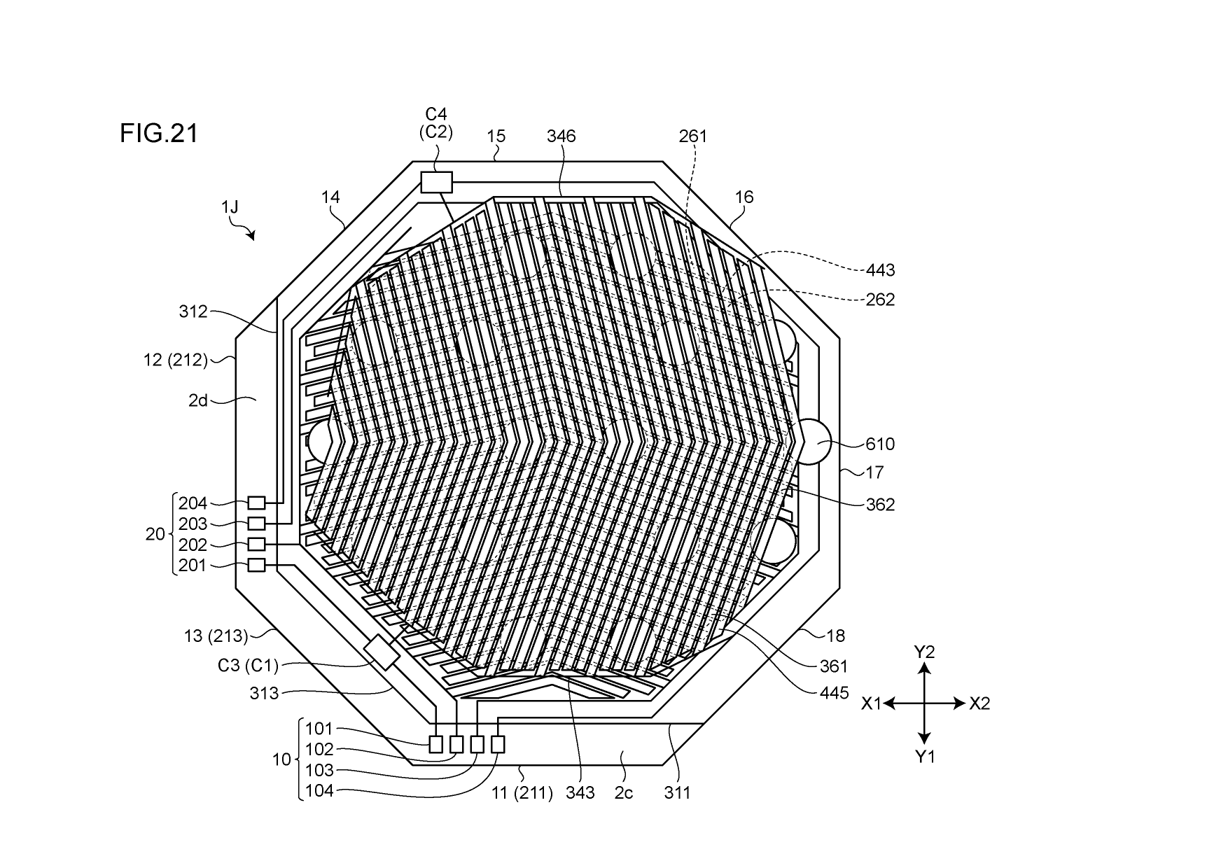

The following describes a fourth embodiment. FIG. 19 is a plan view of a first substrate according to the fourth embodiment. FIG. 20 is a plan view of a second substrate according to the fourth embodiment. FIG. 21 is a plan view of a light adjustment panel obtained by placing the second substrate in FIG. 20 on the upper side of the first substrate in FIG. 19.

Although the insulating layers 443 are provided on the first substrate 2B in the third embodiment, insulating layers 444 and 445 are respectively provided on a first substrate 2C and a second substrate 3C in the fourth embodiment. The specific description thereof is given below.

As illustrated in FIG. 19, the first substrate 2C in a light adjustment panel 1J is identical to the first substrate 2B according to the third embodiment. Specifically, the insulating layers 443 are provided in gaps between the drive electrodes 261 and 262.

As illustrated in FIGS. 20 and 21, the drive electrodes 361 and 362 are alternately disposed with gaps therebetween in the X direction on the second substrate 3C. The insulating layers 445 are provided in gaps between the drive electrodes 361 and 362 adjacent to each other in the X direction. The insulating layers 445 have shapes along the drive electrodes 361 and 362 and have substantially V shapes in plan view. The widths of the insulating layers 445 are substantially equal to the widths of the drive electrodes 361 and 362 adjacent to each other in the X direction. The lengths of the insulating layers 445 are substantially equal to the lengths of the drive electrodes 361 and 362. In the fourth embodiment, the insulating layers 445 are provided in all gaps between the drive electrodes 361 and 362, but in the present disclosure, the insulating layers 445 may be provided in some of the gaps.

As described above, according to the fourth embodiment, the insulating layers 443 are provided in gaps between the drive electrodes 261 and 262 adjacent to each other. The insulating layers 445 are provided in gaps between the drive electrodes 361 and 362 adjacent to each other.

In this case, as in the second embodiment, coloration of emitted light is improved while decrease in transmittance is reduced.

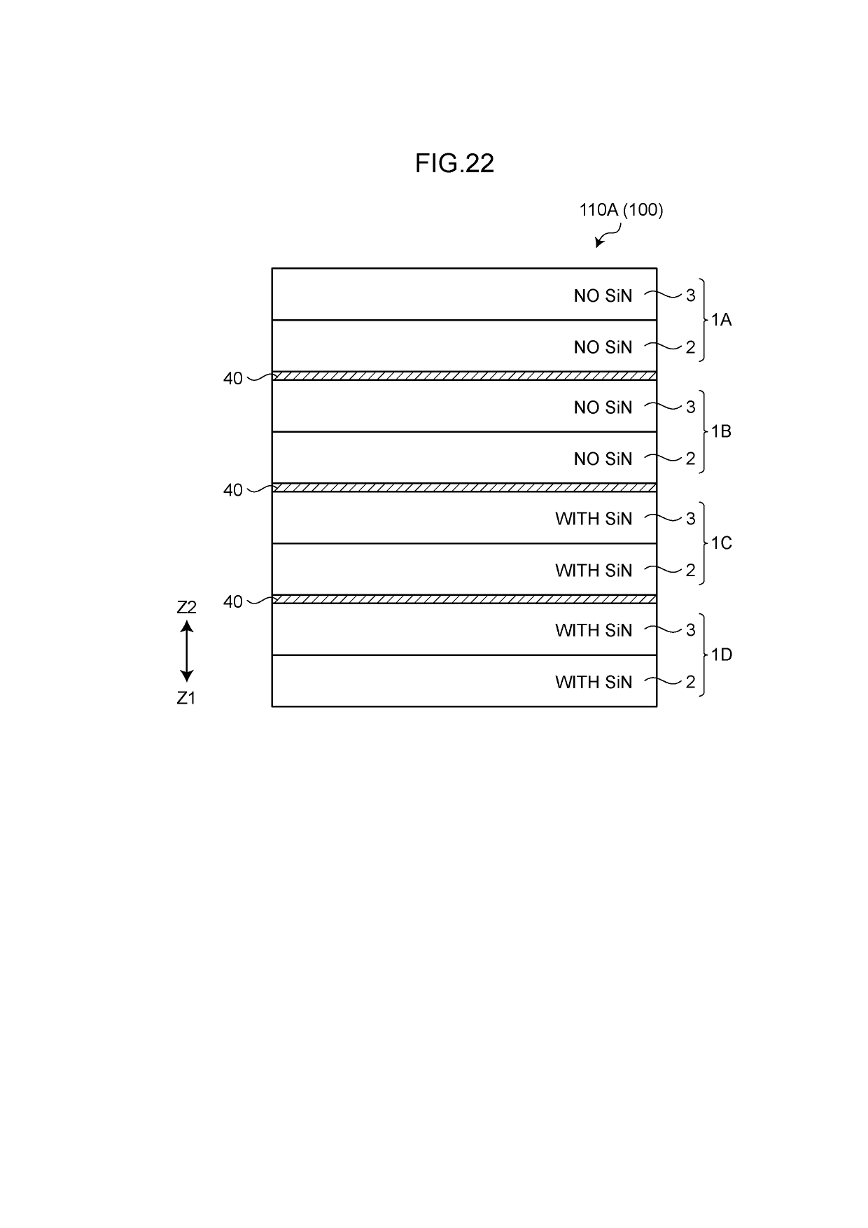

FIG. 22 is a schematic diagram illustrating a section of a panel unit according to a modification. As illustrated in FIG. 22, in a panel unit 110A, the light adjustment panels 1 adjacent to each other in the Z direction are bonded to each other with a bonding layer 40 therebetween. The bonding layer 40 is, for example, an optical clear adhesive (OCA) or an optical clear resin (OCR). Specifically, the bonding layer 40 is disposed between the first light adjustment panel 1A and the second light adjustment panel 1B, between the second light adjustment panel 1B and the third light adjustment panel 1C, and between the third light adjustment panel 1C and the fourth light adjustment panel 1D, and accordingly, the light adjustment panels 1 adjacent to each other in the Z direction are bonded to each other with the bonding layer 40 therebetween. In the panel unit 110A, a total of three bonding layer 40 are provided. The color temperature of light emitted from the panel unit 110A can be improved by, for example, increasing the thickness of each bonding layer 40.

What is claimed is:

1. A light adjustment device comprising a panel unit in which a plurality of light adjustment panels are stacked in a first direction, wherein
at least one of the light adjustment panels includes
a first substrate,
a second substrate overlapping the first substrate when viewed along the first direction,
a liquid crystal layer with which a space between the first substrate and the second substrate is filled,
a first electrode stacked on the first substrate,
a second electrode stacked on the second substrate, and
an insulating layer containing at least one of silicon nitride or silicon oxide, and
the insulating layer is stacked on at least one of the first substrate or the second substrate and is provided in an active area.

2. The light adjustment device according to claim 1, wherein
in the active area, a spacer is provided between the first substrate and the second substrate, and
the spacer and the insulating layer overlap when viewed along the first direction.

3. The light adjustment device according to claim 1, wherein the insulating layer is stacked on at least one of the first electrode or the second electrode.

4. The light adjustment device according to claim 1, wherein
a plurality of the first electrodes are provided with gaps therebetween and a plurality of the second electrodes are provided with gaps therebetween when viewed along the first direction, and
the insulating layer is provided in at least one of a gap between the first electrodes adjacent to each other or a gap between the second electrodes adjacent to each other.
